(19) United States
(12) Patent Application Publication
(10) Pub. No.: US 2023/0368966 A1
(43) Pub. Date: Nov. 16, 2023

(54) COIL COMPONENT

(71) Applicant: SAMSUNG ELECTRO-MECHANICS CO., LTD., Suwon-si (KR)

(72) Inventors: Chan YOON, Suwon-si (KR); Dong Hwan LEE, Suwon-si (KR); Dong Jin LEE, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/095,669

(22) Filed: Jan. 11, 2023

(30) Foreign Application Priority Data
May 10, 2022 (KR) 10-2022-0057052

(51) Int. Cl. H01F 27/29; H01F 27/02; H01F 27/28

(52) U.S. Cl. CPC H01F 27/292; H01F 27/02; H01F 27/2852; H01F 27/24

(57) ABSTRACT

A coil component includes a body having a first surface and a second surface disposed to be perpendicular to a first direction, a third surface and a fourth surface disposed to be perpendicular to a second direction, and a fifth surface and a sixth surface disposed to be perpendicular to a third surface, a coil portion including a first lead-out portion and a second lead-out portion, a first external electrode connected to the first lead-out portion, and a second external electrode connected to the second lead-out portion, wherein the first and second external electrodes are spaced apart from each other in the second direction, and a gap between the first surface and the second surface is greater than a gap between the third surface and the fourth surface and a gap between the fifth surface and the sixth surface.

### CROSS-REFERENCE TO RELATED APPLICATION(S)

This application claims benefit of priority to Korean Patent Application No. 10-2022-0057052 filed on May 10, 2022 in the Korean Intellectual Property Office, the disclosure of which is incorporated herein by reference in its entirety.

### TECHNICAL FIELD

The present disclosure relates to a coil component.

### BACKGROUND

With the miniaturization and slimming of electronic devices such as digital TVs, mobile phones, laptop PCs, and the like, there has been increasing demand for the miniaturization and thinning of coil components used in such electronic devices. To satisfy such demand, research and development of various winding-type or thin film-type coil components have been actively conducted.

A main issue in the miniaturization and thinning of the coil component is to maintain characteristics of an existing coil component in spite of the miniaturization and thinning thereof. To address the issue, a ratio of a magnetic material should be increased in a core in which the magnetic material is filled. However, there may be a limitation in increasing the ratio due to a change in strength of a body of an inductor, frequency characteristics depending on insulation properties of the body, and the like.

### SUMMARY

An aspect of the present disclosure is to implement a coil component appropriate for miniaturization and having inductance characteristics and the like.

According to an aspect of the present disclosure, a coil component includes: a body having a first and second surfaces opposing each other and disposed to be perpendicular to a first direction, third and fourth surfaces opposing each other and connected to the first surface and the second surface, the third and fourth surfaces being disposed to be perpendicular to a second direction, and fifth and sixth surfaces opposing each other and connected to the first to fourth surfaces, the fifth and sixth surfaces being disposed to be perpendicular to a third direction, a gap between the first surface and the second surface is greater than a gap between the third surface and the fourth surface and a gap between the fifth surface and the sixth surface, a coil portion disposed within the body and including a first lead-out portion and a second lead-out portion leading out to the first surface and the second surface of the body, respectively, a first external electrode connected to the first lead-out portion and extending from the first surface of the body to the second surface of the body, and a second external electrode connected to the second lead-out portion and extending from the second surface of the body to the first surface of the body. The first and second external electrodes are spaced apart from each other in the second direction.

The first and second lead-out portions may be disposed in different locations in the second direction.

The first and second external electrodes may be disposed on the first surface and the second surface of the body, and the fifth surface and the sixth surface of the body.

Each of the first and second external electrodes may have a band shape.

The first external electrode may not be disposed on the third surface of the body.

The first external electrode may also be disposed on the third surface of the body.

The second external electrode may not be disposed on the fourth surface of the body.

The second external electrode may also be disposed on the fourth surface of the body.

The first to third directions may be perpendicular to each other.

A winding axis of the coil portion may be parallel to the third direction.

The gap between the third surface and the fourth surface may be greater than the gap between the fifth surface and the sixth surface.

A portion of the first surface may be exposed.

A portion of the second surface may be exposed.

According to an aspect of the present disclosure, a coil component includes: a body having first and second surfaces opposing each other and disposed to be perpendicular to a first direction, third and fourth surfaces opposing each other and connected to the first surface and the second surface, the third and fourth surfaces being disposed to be perpendicular to a second direction, and fifth and sixth surfaces opposing each other and connected to the first to fourth surfaces, the fifth and sixth surfaces being disposed to be perpendicular to a third direction, a coil portion disposed within the body and including a first lead-out portion and a second lead-out portion leading out to the first surface and the second surface of the body, respectively, a first band-shaped external electrode connected to the first lead-out portion, and a second band-shaped external electrode connected to the second lead-out portion.

The first and second band-shaped external electrodes may be spaced apart from each other in the second direction.

The first and second lead-out portions may be disposed in different locations in the second direction.

The first and second band-shaped external electrodes may be disposed on the first surface and a portion of the first surface may be exposed.

The first and second band-shaped external electrodes may be disposed on the second surface and a portion of the second surface may be exposed.

According to an aspect of the present disclosure, a component includes: a substrate, and the coil component according to any aspect of the present disclosure disposed on the substrate. The first surface faces the substrate, and a gap between the first surface and the second surface is greater than a gap between the third surface and the fourth surface and a gap between the fifth surface and the sixth surface.

A winding axis of the coil portion may be parallel to the third direction.

The first and second lead-out portions may be disposed in different locations in the second direction.

The gap between the third surface and the fourth surface may be greater than the gap between the fifth surface and the sixth surface.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic perspective view illustrating a coil component according to an exemplary embodiment in the present disclosure.

FIGS. 2 and 3 are cross-sectional views illustrating a region of the coil component of FIG. 1.

FIG. 4 is a diagram illustrating a coil component according to a modified example.

FIGS. 5A, 5B, 6A, and 6B are diagrams illustrating coil components according to comparative examples.

### DETAILED DESCRIPTION

Hereinafter, embodiments in the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of the elements in the drawings can be exaggerated for clear description. Also, elements having the same function within the scope of the same concept represented in the drawing of each exemplary embodiment will be described using the same reference numeral.

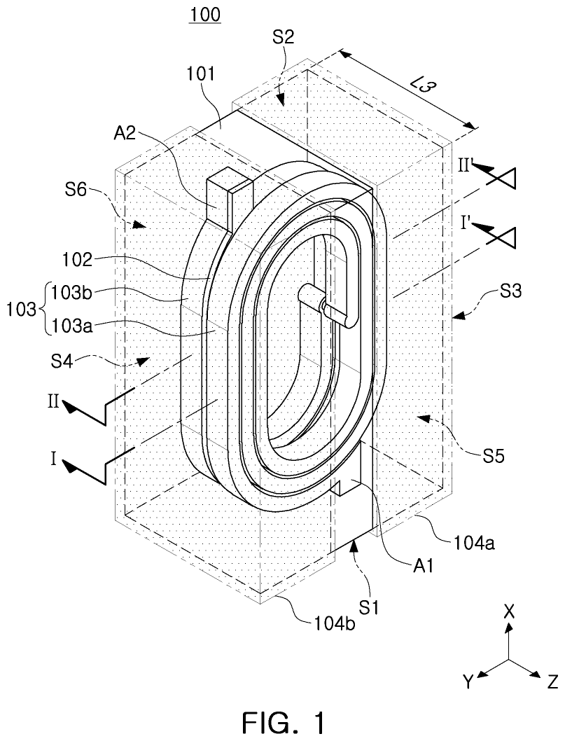

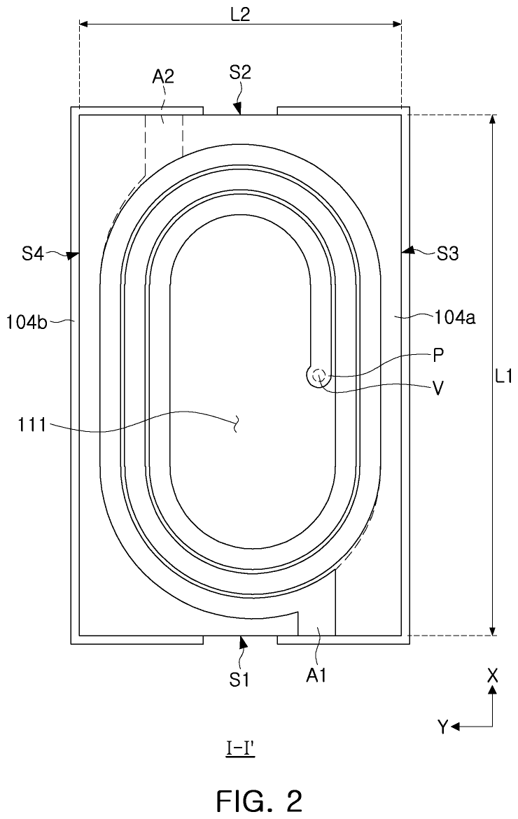

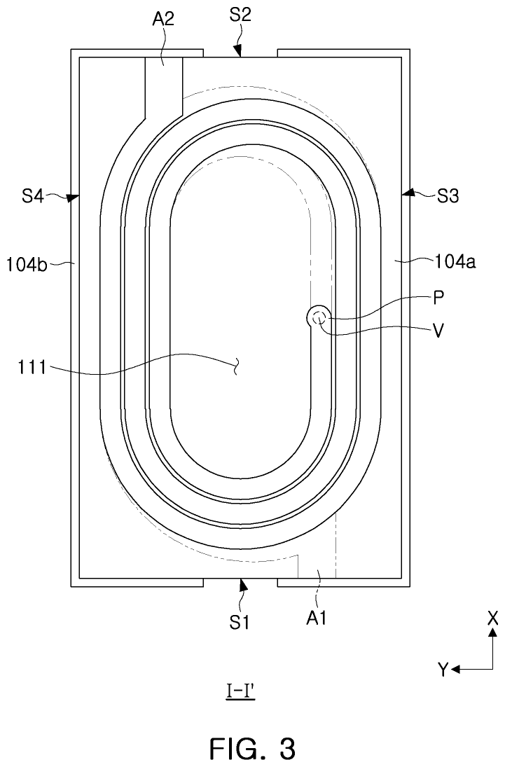

FIG. 1 is a schematic perspective view illustrating a coil component according to an exemplary embodiment. FIGS. 2 and 3 are cross-sectional views illustrating a region of the coil component of FIG. 1. Referring to FIGS. 1 to 3, a coil component 100 according to the present embodiment may include a body 101, a coil portion 103, and first and second external electrodes 104a and 104b as main elements. The first and second external electrodes 104a and 104b may be disposed to be spaced apart from each other in one direction on a first surface S1 and a second surface S2 of the body 101. With respect to size conditions of the body 101, a gap L1 between the first surface S1 and the second surface S2 may be greater than a gap L3 between a fifth surface S5 and a sixth surface S6 of the body 101. Hereinafter, main elements constituting the coil component 100 according to the present embodiment will be described.

The body 101 may include a coil portion 103, and the like, disposed therein and may form an overall exterior of the coil component 100. The body 101 may have a first surface S1 and a second surface S2 disposed to be perpendicular to a first direction (an X-direction) while opposing each other. Also, the body 101 may have a third surface S3 and a fourth surface S4. The third surface S3 and the fourth surface S4 may connect the first surface S1 and the second surface S2 to each other while opposing each other. When a direction perpendicular to the third surface S3 and the fourth surface S4 is referred to as a second direction (a Y-direction), the second direction (the Y-direction) may be perpendicular to the first direction (the X-direction). The body 101 may further have a fifth surface S5 and a sixth surface S6 connected to the first to fourth surfaces S1 to S4 and disposed to be perpendicular to a third direction (a Z-direction) while opposing each other. In this case, the first, second, and third directions (the X-direction, the Y-direction, and the Z-direction) may be perpendicular to each other. As described above, the gap L1 between the first surface S1 and the second surface S2 of the body 101 may be greater than the gap L2 between the third surface S3 and the fourth surface S4. In addition, the gap L1 between the first surface S1 the fourth surface and the second surface S2 may be greater than a gap L3 between the fifth surface S5 and the sixth surface S6. Furthermore, the gap L2 between the third surface S3 and the fourth surface S4 may be greater than and the gap L3 between the fifth surface S5 and the sixth surface S6. As will be described later, such a shape of the body 101 may be appropriate to dispose the coil component 100 on a substrate, or the like, so that the first surface S1 serves as a mounting surface. The gap L1 between the first surface S1 and the second surface S2 may correspond to a gap measured in the first direction (the X-direction), but the first surface S1 and the second surface S2 may not be completely parallel to each other. In this case, the gap L1 may be defined as a minimum distance between the first surface S1 and the second surface S2. The same criteria may be applied to the gaps L2 and L3.

The gaps L1, L2, and L3 may be measured by an optical microscope. Other methods and/or tools appreciated by one of ordinary skill in the art, even if not described in the present disclosure, may also be used.

The body 101 may include an insulating resin and a magnetic material. For example, the body 101 may be formed by laminating one or more magnetic composite sheets in which a magnetic material is dispersed in an insulating resin. The magnetic material may be, for example, a ferrite powder particle or a magnetic metal powder particle. Examples of the ferrite powder particle may include at least one or more of spinel type ferrites such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, and the like, hexagonal ferrites such as Ba—Zn-based ferrite, Ba—Mg-based ferrite, Ba—Ni-based ferrite, Ba—Co-based ferrite, Ba—Ni—Co-based ferrite, and the like, garnet type ferrites such as Y-based ferrite, and the like, and Li-based ferrites. The magnetic metal powder particle may include one or more selected from the group consisting of iron (Fe), silicon (Si), chromium (Cr), cobalt (Co), molybdenum (Mo), aluminum (Al), niobium (Nb), copper (Cu), and nickel (Ni) For example, the magnetic metal powder particle may be at least one or more of a pure iron powder, a Fe—Si-based alloy powder, a Fe—Si—Al-based alloy powder, a Fe—Ni-based alloy powder, a Fe—Ni—Mo-based alloy powder, a Fe—Ni—Mo—Cu-based alloy powder, a Fe—Co-based alloy powder, a Fe—Ni—Co-based alloy powder, a Fe—Cr-based alloy powder, a Fe—Cr—Si-based alloy powder, a Fe—Si—Cu—Nb-based alloy powder, a Fe—Ni—Cr-based alloy powder, and a Fe—Cr—Al-based alloy powder. The metallic magnetic material may be amorphous or crystalline. For example, the magnetic metal powder particle may be a Fe—Si—B—Cr-based amorphous alloy powder, but exemplary embodiments are not limited thereto. Each of the ferrite powder and the magnetic metal powder particle may have an average diameter of about 0.1 μm to 30 μm, but exemplary embodiments are not limited thereto. The body 100 may include two or more types of magnetic materials dispersed in a resin. In this case, the term “different types of magnetic material” means that the magnetic materials dispersed in the resin are distinguished from each other by average diameter, composition, crystallinity, and a shape. The resin may include an epoxy, a polyimide, a liquid crystal polymer, or the like, in a single form or in combined forms, but exemplary embodiments are not limited thereto.

With respect to an example of the manufacturing method, the body 101 may be formed by a lamination method. For example, a plurality of unit laminates for manufacturing the body 101 may be prepared and laminated on upper and lower portions of the coil portion 103. The unit laminate is prepared by mixing magnetic particles such as a metal and an organic material such as a thermosetting resin, a binder, and a solvent to prepare a slurry, applying the slurry to a carrier film using a doctor blade method to have a thickness of several tens of micrometers (μm), drying the slurry, and manufacturing the unit laminate in the form of a sheet. Accordingly, the unit laminate may be manufactured to have a form in which magnetic particles are dispersed in a thermosetting resin such as an epoxy resin, a polyimide, or the like.

The support member 102 may support the coil portion 103 and may be formed as, for example, a polypropylene glycol (PPG) substrate, a ferrite substrate, or a metal-based soft magnetic substrate. However, the support member 102 may not be provided according to example embodiments. For example, when a coil having a winding-type structure is used, the support member 102 may not be required. As illustrated in the drawings, a through-hole may be formed to penetrate through a portion of the support member 102, and may be filled with a material forming the body 101. Accordingly, a core portion 111 may be formed in the coil portion 103. The support member 102 is not an essential component in the present disclosure and may be omitted according to example embodiments.

The coil portion 103 may be provided inside the body 101 and may serve to perform various functions in an electronic device through characteristics exhibited from a coil of the coil component 100. For example, the coil component 100 may be a power inductor. In this case, the coil portion 103 may store electricity in the form of a magnetic field, serving to maintain an output voltage to stabilize power. In this case, a coil pattern constituting the coil portion 103 may include first and second coil portions 103a and 103b, respectively disposed on opposite surfaces of the support member 102. A conductive via V, penetrating through the support member 102, may be provided to connect the first and second coil portions 103a and 103b to each other, and the coil portion 103 may include a pad region P. Alternatively, the coil portion 103 may be disposed on only one surface of the support member 102. The coil pattern, constituting the coil portion 103, may be formed using a plating process common in the art, for example, pattern plating, anisotropic plating, isotropic plating, or the like, and may be formed to have a multilayer structure using a plurality of processes, among the above-mentioned processes.

The coil portion 103 may include a winding region forming at least one turn, and may include first and second lead-out portions A1 and A2 connected to the winding region to be exposed to a surface of the body 101. For example, the first lead-out portion A1 may be led out to the first surface S1 of the body 101 to be connected to the first external electrode 104a, and the second lead-out portion A2 may be led out to the second surface S2 of the body 101 to be connected to the second external electrode 104b. In this case, the first and second lead-out portions A1 and A2 may be disposed to be shifted in the second direction (the Y-direction), for example, disposed in different positions, which may be defined in a form in which the first and second lead-out portions A1 and A2 are spaced apart from each other to have a predetermined pitch in the second direction (the Y-direction) with respect to the cross-section of FIG. 2. As a more detailed example, centers of the first and second lead-out portions A1 and A2 in the second direction (the Y-direction) may be disposed in different locations in the second direction (Y direction). With respect to a direction in which the coil portion 103 is disposed, a winding axis of the coil portion 103 may be parallel to the third direction (the Z-direction).

The coil portion may be provided in a form, other than the form illustrated in FIGS. 1 to 3. For example, the coil portion may be implemented as a winding-type coil. In this case, the support member supporting the coil portion may not be disposed inside the body 101. A winding-type coil portion may be a winding-type coil formed by winding a metal wire such as a copper (Cu) wire including a metal line and a coating layer coating a surface of the metal line. Accordingly, an entire surface of each of a plurality of turns of the coil portion may be covered with the coating layer. The metal wire may be a flat-type wire, but exemplary embodiments are not limited thereto. When the coil portion is formed using a flat-type wire, a cross-section of each of the plurality of turns of the coil portion may have a rectangular shape. The coating layer may include an epoxy, a polyimide, a liquid crystal polymer, or mixture thereof, but exemplary embodiments are not limited thereto.

The first and second external electrodes 104a and 104b may be formed outside the body 101 to be connected to the first and second lead-out portions A1 and A2. The first and second external electrodes 104a and 104b may be formed using a paste including a metal having improved electrical conductivity. For example, the paste may be a conductive paste including nickel (Ni), copper (Cu), tin (Sn), silver (Ag), or alloys thereof. A plating layer may be further formed on each of the first and second external electrodes 104a and 104b. In this case, the plating layer may include at least one selected from the group consisting of nickel (Ni), copper (Cu), and tin (Sn). For example, the plating layer may include a nickel (Ni) layer and a tin (Sn) layer sequentially formed.

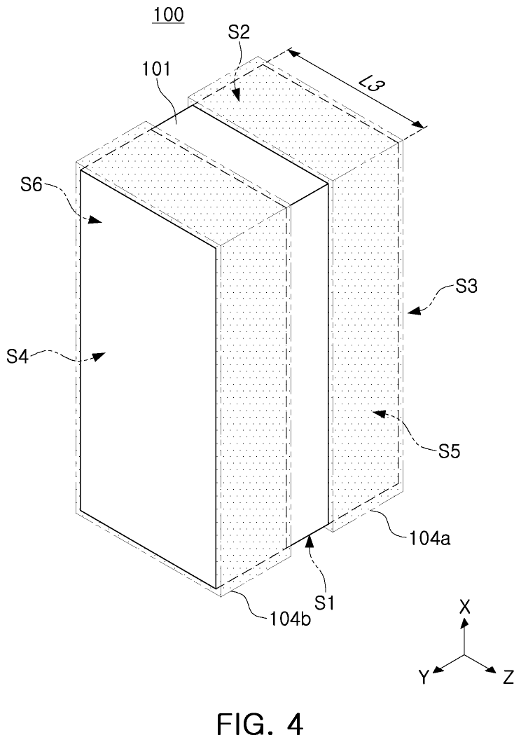

In the present embodiment, the first external electrode 104a may extend from the first surface S1 of the body 101 to the second surface S2 of the body 101, and the second external electrode 104b may extend from the second surface S2 of the body 101 to the second surface S1 of the body 101. This may correspond to a form in which the first external electrode 104a extends to the second surface S2, opposing the first surface S1, while being connected to the first lead-out portion A1 on the first surface S1, and the second external electrode 104b extends to the first surface S1, opposing the second surface S1, while being connected to the second lead-out portion A2 on the second surface S2. To this end, the first and second external electrodes 104a and 104b may be disposed on the first surface S1 and the second surface S2 and the third surface S3 and the fourth surface S4 of the body 101. In addition, as illustrated in the drawings, the first external electrode 104a may also be disposed on the third surface S3 of the body 101, and the second external electrode 104b may also be disposed on the fourth surface S4 of the body 101. However, as in the modified example of FIG. 4, the first external electrode 104a may not be disposed on the third surface S3 of the body 101, and the second external electrode 104b may not be disposed on the fourth surface S4 of the body 101. In this case, each of the first and second external electrodes 104a and 104b may have a band shape.

The coil component 100 having the above-described structure may have a form appropriate such that the winding axis direction (the Z-axis direction) of the coil portion is disposed to be parallel to a mounting surface when the coil component 100 is mounted on a substrate, or the like. In this case, the mounting surface may be the first surface S1 of the body 101. In the case of such a mounting method, an area of the core portion 111 may be sufficiently secured and the degree of freedom of design for a margin from an external portion of the coil component 100 to the coil portion 103 may be increased, so that it may be advantageous to implement high performance, for example, high inductance, a high Q value, and low resistance. Furthermore, when the coil component 100 is mounted such that the first surface S1 is directed toward the substrate, the first and second external electrodes 104a and 104b may be disposed to be spaced apart from each other in the second direction (the Y-direction), and thus, short-circuit defects may be effectively reduced to improve reliability of the coil component 100.

In addition, as described in the present embodiment, when the body 101 has size conditions of L1>L2 and L1>L3, the first and second lead-out portions A1 and A2 may be respectively led out to both surfaces opposing each other in the first direction (the X-direction), so that it may be advantageous to improve characteristics of the coil component 100. The present inventors conducted a performance experiment according to an embodiment and comparative examples, and results of the performance experiment are listed in Table 1.

### Table 1

TABLE 1

| | | Comparative | Comparative |
|---|---|---|---|
| | Embodiment | Example 1 | Example 2 |
| L (μH) | 0.66487 | 0.61523 | 0.52492 |
| R_{dc} (mΩ) | 38.925652 | 38.70118813 | 38.74167054 |

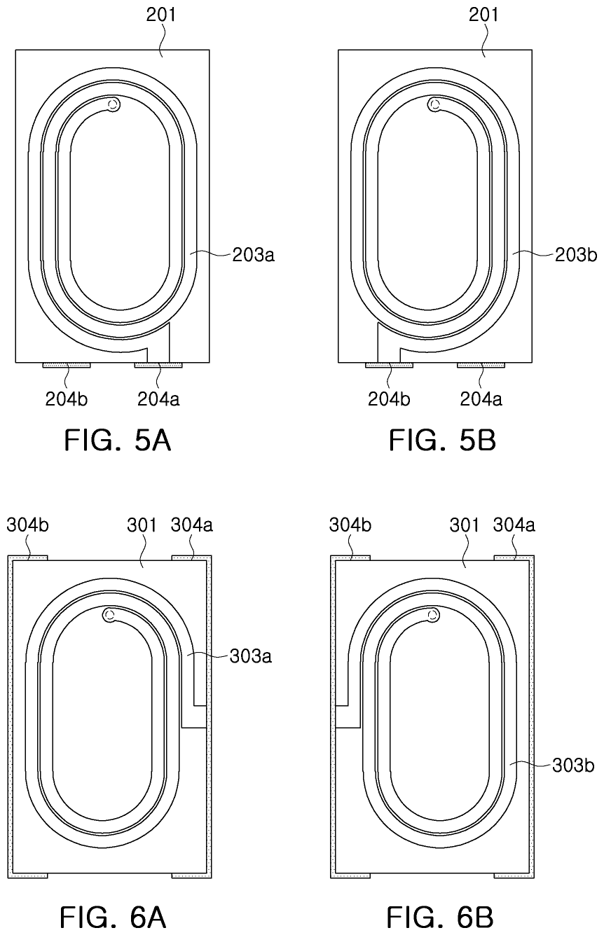

In the case of Embodiment, a coil component had the structure as shown in FIGS. 1 to 3 and a body was manufactured to have a size, as follows: L1=2.0 mm, L2=1.2 mm, and L3=1.0 mm. In the case of Comparative Example 1, a coil component had a structure as shown in FIGS. 5A and 5B. Unlike the Embodiment, in coil portions 203a and 203b, a pair of lead-out portions were led out to a first surface of a body 201 to be connected to external electrodes 204a and 204b. In the case of Comparative Example 2, a coil component had a structure as shown in FIGS. 6A and 6B. Unlike the Embodiment, in coil portions 303a and 303b, a pair of lead-out portions were led out to opposite side surfaces (corresponding to a third surface and a fourth surface) of a body 301 to be connected to external electrodes 304a and 304b. In each of Comparative Examples 1 and 2, a body was manufactured to have a size, as follows: L1=2.0 mm, L2=1.2 mm, and L3=1.0 mm. Performances of the coil components manufactured according to Embodiment and Comparative Examples were measured with respect to a state of being disposed on a substrate such that a first surface (a lower surface based on the drawings) of the body was a mounting surface.

As can be seen from Table 1, the coil component according to Embodiment exhibited significantly improved inductance characteristics L while having electrical characteristics R_{dc}, similar to those of Comparative Examples. This is understood to be because a disposition method of lead-out portions and external electrodes was implemented in the above-described structure to increase the number of turns (about 5.5 turns) as compared with Comparative Examples (Comparative Example 1: about 5 turns, Comparative Example 2: about 4.5 turns).

On the other hand, inductance characteristics were measured by changing only a size condition of a body while maintaining a disposition method of lead-out portions and external elements. According to a result of the measurement, inductance was highest when L1>L2>L3. In detail, as can be seen from Table 1, an inductance characteristic of about 0.66 pH was exhibited in Embodiment, whereas a significantly reduced inductance characteristic of about 0.54 pH was exhibited in the coil component manufactured under a condition of L2 (2.0 mm)>L1 (1.2 mm)>L3 (0.8 mm) or L2 (2.0 mm)>L3 (1.2 mm)>L1 (0.8 mm).

As described above, a coil component according to an exemplary embodiment may be appropriate for miniaturization and may have improved inductance characteristics and the like.

While example embodiments have been shown and described above, it will be apparent to those skilled in the art that modifications and variations could be made without departing from the scope of the present invention as defined by the appended claims.

What is claimed is:

1. A coil component comprising:
a body having:
first and second surfaces opposing each other and disposed to be perpendicular to a first direction,
third and fourth surfaces opposing each other and connected to the first surface and the second surface, the third and fourth surfaces being disposed to be perpendicular to a second direction, and
fifth and sixth surfaces opposing each other and connected to the first to fourth surfaces, the fifth and sixth surfaces being disposed to be perpendicular to a third direction, wherein a gap between the first surface and the second surface is greater than a gap between the third surface and the fourth surface and a gap between the fifth surface and the sixth surface;
a coil portion disposed within the body and including a first lead-out portion and a second lead-out portion leading out to the first surface and the second surface of the body, respectively;
a first external electrode connected to the first lead-out portion and extending from the first surface of the body to the second surface of the body; and
a second external electrode connected to the second lead-out portion and extending from the second surface of the body to the first surface of the body,
wherein the first and second external electrodes are spaced apart from each other in the second direction.

2. The coil component of claim 1, wherein
the first and second lead-out portions are disposed in different locations in the second direction.

3. The coil component of claim 1, wherein
the first and second external electrodes are disposed on the first surface and the second surface of the body, and the fifth surface and the sixth surface of the body.

4. The coil component of claim 3, wherein
each of the first and second external electrodes has a band shape.

5. The coil component of claim 4, wherein
the first external electrode is not disposed on the third surface of the body.

6. The coil component of claim 3, wherein
the first external electrode is also disposed on the third surface of the body.

7. The coil component of claim 4, wherein
the second external electrode is not disposed on the fourth surface of the body.

8. The coil component of claim 3, wherein
the second external electrode is also disposed on the fourth surface of the body.

9. The coil component of claim 1, wherein
the first to third directions are perpendicular to each other.

10. The coil component of claim 9, wherein
a winding axis of the coil portion is parallel to the third direction.

11. The coil component of claim 1, wherein
the gap between the third surface and the fourth surface is greater than the gap between the fifth surface and the sixth surface.

12. The coil component of claim 1, wherein a portion of the first surface is exposed.

13. The coil component of claim 1, wherein a portion of the second surface is exposed.

14. A coil component comprising:
a body having:
first and second surfaces opposing each other and disposed to be perpendicular to a first direction,
third and fourth surfaces opposing each other and connected to the first surface and the second surface, the third and fourth surfaces being disposed to be perpendicular to a second direction, and
fifth and sixth surfaces opposing each other and connected to the first to fourth surfaces, the fifth and sixth surfaces being disposed to be perpendicular to a third direction;
a coil portion disposed within the body and including a first lead-out portion and a second lead-out portion leading out to the first surface and the second surface of the body, respectively;
a first band-shaped external electrode connected to the first lead-out portion; and
a second band-shaped external electrode connected to the second lead-out portion.

15. The coil component of claim 12, wherein
the first and second band-shaped external electrodes are spaced apart from each other in the second direction.

16. The coil component of claim 12, wherein
the first and second lead-out portions are disposed in different locations in the second direction.

17. The coil component of claim 14, wherein
the first and second band-shaped external electrodes are disposed on the first surface and a portion of the first surface is exposed.

18. The coil component of claim 14, wherein
the first and second band-shaped external electrodes are disposed on the second surface and a portion of the second surface is exposed.

19. A component comprising:
a substrate; and
the coil component of claim 14 disposed on the substrate, wherein the first surface faces the substrate, and a gap between the first surface and the second surface is greater than a gap between the third surface and the fourth surface and a gap between the fifth surface and the sixth surface.

20. The coil component of claim 19, wherein
a winding axis of the coil portion is parallel to the third direction.

21. The coil component of claim 19, wherein
the first and second lead-out portions are disposed in different locations in the second direction.

22. The coil component of claim 19, wherein
the gap between the third surface and the fourth surface is greater than the gap between the fifth surface and the sixth surface.
